(19) United States
(12) Patent Application Publication
(10) Pub. No.: US 2025/0144498 A1
(43) Pub. Date: May 8, 2025

(54) GRASS MAT APPARATUS FOR EXERCISING GOLF

(71) Applicant: Gil Sung KIM, Seoul (KR)

(72) Inventor: Gil Sung KIM, Seoul (KR)

(21) Appl. No.: 18/885,591

(22) Filed: Sep. 14, 2024

(30) Foreign Application Priority Data
Nov. 7, 2023 (KR) 10-2023-0152418

(51) Int. Cl. A63B 69/36; E01C 13/08

(52) U.S. Cl. CPC A63B 69/3661; E01C 13/083

(57) ABSTRACT

A natural grass mat apparatus for golf practice includes: a housing (100); first and second drive parts (130a, 130b) provided in the housing (100) and arranged side by side along a first direction; a conveyor belt (120) provided in the housing (100) and moving around the first and the second drive parts (130a, 130b); a natural grass mat (140) provided over an outer surface of the conveyor belt (120); a first fixed support member (150a) extending substantially in a second direction from the first drive part (130a) toward a bottom of the housing (100) and supporting the first drive parts (130a), wherein the second direction is perpendicular to the first direction; and a second fixed support member (150b) extending substantially in the second direction from the second drive part (130b) toward the bottom of the housing (100) and supporting the second drive part (130a).

### CROSS-REFERENCE TO RELATED APPLICATION

This application claims the benefit of and priority to Korean Patent Application No. 10-2023-0152418 filed on Nov. 7, 2023, which is herein incorporated by reference in its entirety.

### TECHNICAL FIELD

The present invention relates to a natural grass mat apparatus for golf practice. More particularly, the natural grass mat apparatus can be installed on screen golf courses or indoor golf driving ranges. The natural grass mat apparatus includes a golf practice mat with natural grass vegetation so that swinging and hitting practice can be carried out under the condition similar to a real golf field.

### TECHNICAL BACKGROUND

Typically, driving ranges are arranged in a uniformly sized and spaced area to accommodate a large number of people in a limited space. The driving ranges have artificial mats. The golf practice mats are made of plastic or synthetic resin. Thus, it is hard to get a feel of swinging a golf club on natural grass. It is also hard to hit a ball with an accurate square and impact on artificial mats, compared with playing on natural grass.

This means that golfers are unable to square the golf ball accurately, and even if they hit the back of the ball, called duff shot, the golf club is pushed against the slippery artificial mat, preventing golfers from learning how to square the golf ball accurately and swing correctly.

In addition, another crucial difference between when playing on an artificial mat and when playing on natural grass is the weight impact. When a golfer hits a ball on an artificial mat, only the ball is hit. In contrast, when a golfer plays on natural grass, both the ball and the grass are impacted when hit.

This can lead to a different weight when someone who is used to practicing on an artificial mat plays golf on a real grass field. The different weight of the club as it touches the ground stops them in their tracks, and a swing that glides to a finish on the range is interrupted on the field.

As a result, a method is required that utilizes natural grass for golf practice mats to address the aforementioned drawbacks of artificial mats and to facilitate the learning of squaring the club to accurately strike the golf ball and maintaining a balanced swing.

### PRIOR ART

Korean Unexamined Publication No. 10-2023-0039843 (2023 Mar. 22.)
(Title: A MAT FOR GOLF EXERCISE BEING ABLE ADHERE AND EXTRACT ARTIFICIAL TURF)

### Problems to be Solved

An objective of the present invention is to provide a natural grass mat for golf practice. The natural grass mat can be installed on screen golf courses or indoor golf driving ranges to provide golfers with an environment similar to a real field.

The objectives of the present invention are not limited to those mentioned above. Additional objectives will become apparent to one of ordinary skill in the art from the following description.

A natural grass mat apparatus for golf practice is provided which includes: a housing (100); first and second drive parts (130a, 130b) provided in the housing (100) and arranged side by side along a first direction; a conveyor belt (120) provided in the housing (100) and moving around the first and the second drive parts (130a, 130b); a natural grass mat (140) provided over an outer surface of the conveyor belt (120); a first fixed support member (150a) extending substantially in a second direction from the first drive part (130a) toward a bottom of the housing (100) and supporting the first drive parts (130a), wherein the second direction is perpendicular to the first direction; and a second fixed support member (150b) extending substantially in the second direction from the second drive part (130b) toward the bottom of the housing (100) and supporting the second drive part (130a). An opening (110h) is formed through a housing top surface (110a) of the housing (100) to expose partially or entirely the natural grass mat (140).

The natural grass mat apparatus for golf practice may further include mat fixing members (125) coupling the natural grass mat (140) and the conveyor belt (120) with each other.

The natural grass mat (140) may include: a vegetation mattress (141) made using coconut fiber (COCO Coir), jute fiber (Jute Felt), Rock Wool, or a combination thereof; and a vegetated grass layer (142) grown from the vegetation mattress (141). The vegetation mattress (141) includes grass nutrients and latex.

The natural grass mat apparatus for golf practice may further include: a first operation part (10) transmitting a first control command to the first and the second drive parts (130a, 130b). In response to the first control command, the first and the second drive parts (130a, 130b) rotationally drive the conveyor belt (120) to move the natural grass mat (140).

Each of the first and the second fixed support members (150a, 150b) is extendable and retractable in the second direction.

The natural grass mat apparatus for golf practice may further include a second operation part (20) transmitting a second control command to the first and the second drive parts (130a, 130b). In response to the second control command, the first and the second fixed support members (150a, 150b) (i) extends in the second direction to lift up the natural grass mat (140) in the second direction, or (ii) retracts in the second direction to lower down the natural grass mat (140) in the second direction.

The natural grass mat apparatus for golf practice may further include a first connecting portion (160a) connecting the first fixed support member (150a) and the second fixed support member (150b) to each other.

The natural grass mat apparatus for golf practice may further include rollers (170) arranged side by side in the first direction. Each of said rollers (170) provided under an inner surface of the conveyor belt (120) and rotatably coupled with the first connecting portion (160a) to guide movement of the conveyor belt in the first direction. The inner surface of the conveyor belt (120) is the opposite side of the outer surface of the conveyor belt (120).

Each of the first and the second mat fixing members (125) is formed in a L-shape. Each of the first and the second mat fixing members (125) is extending in the second direction from the conveyor belt (120) and bending in the L-shape in a third direction to accommodate the natural grass mat (140). The third direction is perpendicular to the first direction and the second direction.

### BRIEF DESCRIPTION OF DRAWINGS

FIG. 1 is a perspective view illustrating a natural grass mat for golf practice, according to one embodiment of the present invention.

FIG. 2 is another perspective view of the natural grass practice mat device of FIG. 1.

FIG. 3 is a drawing to illustrate a support and a conveyor drive structure of the natural grass mat apparatus for golf practice of FIG. 1.

FIG. 4 is a diagram illustrating a golf driving range equipped with a natural grass mat for golf practice, according to one embodiment of the present invention.

FIG. 5 is an enlarged view of the area “a” shown in FIG. 1.

FIG. 6 is a cross-sectional view illustrating a natural grass mat according to one embodiment of the present invention.

FIG. 7 is a drawing illustrating operation parts (10, 20) according to one embodiment of the present invention.

### DETAILED DESCRIPTION

The following description is merely illustrative of the principles of the invention. Therefore, those skilled in the art may invent various devices embodying the principles of the invention and falling within the concepts and scope of the invention, even though not specifically described or shown herein. Further, it is to be understood that all conditional terms and embodiments listed herein are expressly intended solely for the purpose of enabling the concepts of the invention to be understood in principle, and are not intended to be limited to the embodiments and conditions specifically listed as such.

Also, in the following descriptions, ordinal expressions such as first, second, etc. are intended to describe objects that are equivalent and independent of each other, and should be understood to have no main/sub or master/slave implications in that order.

The foregoing objects, features and advantages will become more apparent from the following detailed description with reference to the accompanying drawings, which will enable one having ordinary skill in the technical field to which the invention belongs to practice the technical ideas of the invention with ease.

Each of the features of the various embodiments of the present invention can be combined or combined with each other, in part or in whole, and as will be fully appreciated by those skilled in the art, various technical interlockings and operations are possible, and each embodiment can be practiced independently of each other or together in association.

Hereinafter, various embodiments of the present invention will be described in detail with reference to the accompanying drawings.

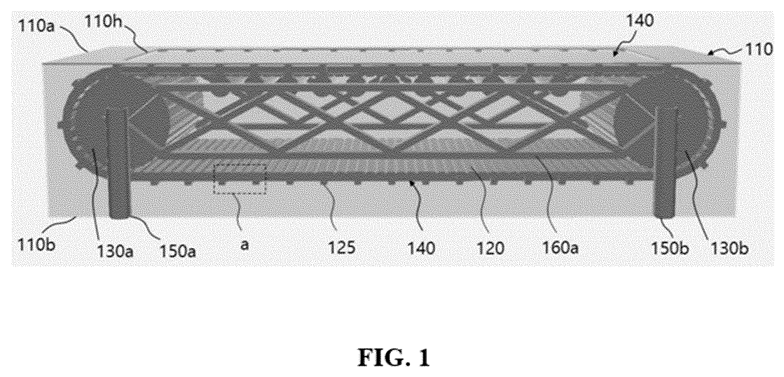

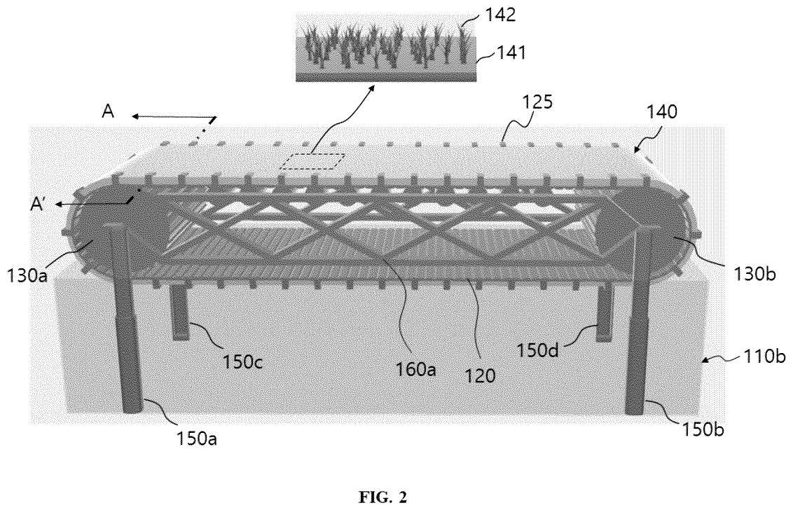

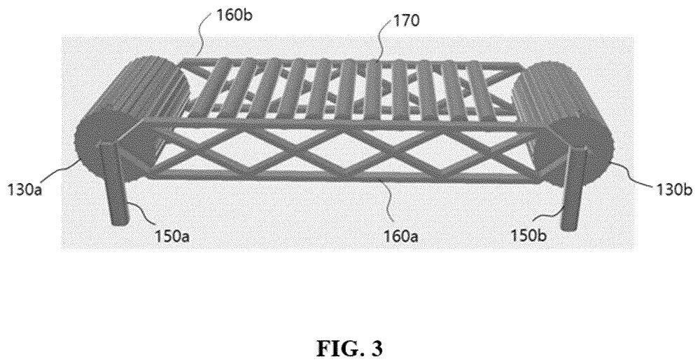

FIG. 1 is a perspective view of a natural grass mat for golf practice, according to one embodiment of the present invention. FIG. 2 is another perspective view of the natural grass matting apparatus for golf practice of FIG. 1. FIG. 3 is a diagram illustrating a support and a conveyor drive structure of the natural grass practice mat apparatus of FIG. 1.

Referring to FIGS. 1 to 3, a natural grass mat apparatus for golf practice (hereinafter, referred to as a natural grass mat apparatus) according to one embodiment of the present invention includes a housing 110, a conveyor belt 120, drive parts 130a, 130b, and a natural grass mat 140, first and second fixed support members 150a to 150d, first and second connecting portions 160a, 160b, and rollers 170. The natural grass mat apparatus may further include a first operation part 10 for controlling the drive parts 130a, 130b, to move the drive parts 130a, 130b. For example, in response to the first control command, the first and the second drive parts 130a, 130b rotationally drive the conveyor belt (120) to adjust locations, directions, or slopes of the drive parts 130a, 130b.

The first fixed support member 150a extends substantially in a second direction from the first drive part 130a toward a bottom of the housing 100 and supports the first drive parts (130a). Likewise, the second fixed support member 150b extends substantially in the second direction from the second drive part 130b toward the bottom of the housing 100 and supports the second drive part (130a), The second direction is substantially perpendicular to the first direction.

The natural grass mat apparatus may further include a second operation part 20 for controlling the fixed support members 150a to 150d. In response to the second control command, the first and the second fixed support members (150a, 150b) (i) extends in the second direction to lift up a height level of the natural grass mat (140), or (ii) retracts in the second direction to lower down the height level of the natural grass mat (140).

The housing 110 includes a housing top surface 110a; an opening 110h which is formed on the housing top surface 110a; and a housing receptacle 110b. The apparatus body is installed in the housing receptacle 110b. The opening 110h formed through the housing top surface 110a of the housing 110 to exposes partially or entirely the natural grass mat 140 for use by a user as a golf practice mat.

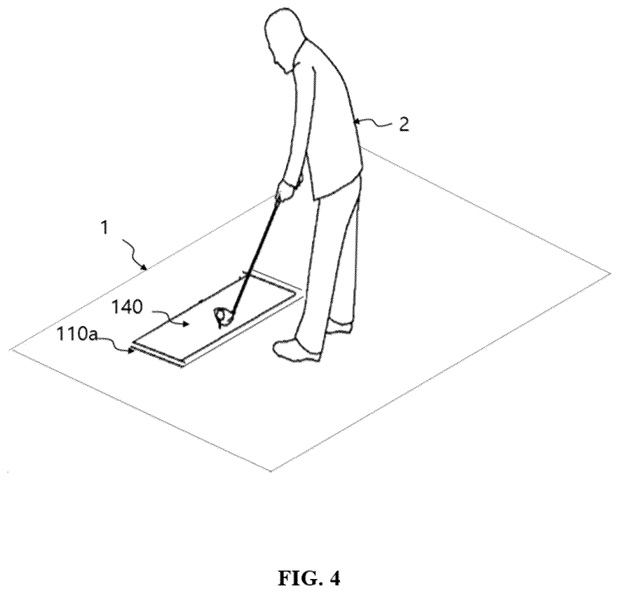

FIG. 4 is a diagram illustrating a golf driving range with a natural grass matting device for golf practice according to one embodiment of the present invention. Referring to FIG. 4, the natural grass mat for golf practice according to one embodiment of the present invention may be installed and used on screen golf courses or indoor golf driving ranges. The housing (100) is installed in a floor surface 1 so that the natural grass mat (140) is substantially flushed with the floor surface 1. A user is standing on the floor surface for practice swing. For example, a pit or a hole or a recess is formed in the floor surface 1, and then the housing (100) is accommodated in the pit or a hole. The top surface 110a of the housing flushes with the floor surface 1. That is, the top surface 110a of the housing and the floor surface 1 are located at the same level as each other in height.

In an embodiment, the housing top surface 110a may be, for example, 1000 mm in length and 350 mm in width. The housing receptacle 110b may be, for example, 200 mm in height, 1000 mm or more in length and 350 mm or more in width. The dimensions may also be adjusted as needed variously according to the installation environment.

The conveyor belt 120 may be provided inside the housing receptacle 110b, and a natural grass mat 140 may be fixedly coupled to the outer surface of the conveyor belt (120). The conveyor belt 120 may be driven by the drive parts 130a, 130b. The drive parts 130a, 130b may be provided at both ends of the conveyor belt 120 to rotationally move the conveyor belt 120 in a first direction, either in one direction or in the opposite direction. Here, the first direction is the direction which the conveyor belt 120 extends along and moves in. Accordingly, the natural grass mat apparatus according to one embodiment of the present invention can be installed in the housing 110, which is buried in the floor surface 1.

Conventionally, there were no commercialized grass mats for golf available; they were only mentioned in a few prior patents. However, due to their structural design, these grass mats required a large installation area, making it impossible to install them in indoor spaces. See Japanese Patent Publication No. 2009-273600.

The conveyor belt 120 may include multiple mat fixing members 125. The mat fixing members 125 couples the natural grass mat 140 and the conveyor belt 120 together. Each of the first and the second mat fixing members 125 is formed in a U-shape, wherein the U-shape is open in a third direction to accommodate the stack layer of the natural grass mat 140 and the conveyor belt 120. The third direction is perpendicular to the first direction and the second direction The mat fixing members 125 are arranged to be spaced apart from each other at a predetermined interval in the first direction.

The mat fixing members 125 may be provided at both edges of the conveyor belt 120. For convenience of explanation, among the mat fixing members 125, two neighboring mat fixing members 125 arranged on the same edge of the conveyor belt 120 may be referred to as first and second mat fixing members 125.

A natural grass mat 140 may be inserted into the mat fixing members 125 and secured by the mat fixing members 125. In general, a golf driving range or a screen golf course has a limited space and uses a fixed mat due to the limited space. The fixed mat, however, makes it difficult to replace it with a new mat. In contrast, the present invention employs a moving mat. According to the present invention, the natural grass mat 140 can be moved by using the conveyor belt 120. Thus, a used natural grass mat 140 can be easily replaced with a new natural grass mat 140. Accordingly, golf practice is possible in the best conditions every time.

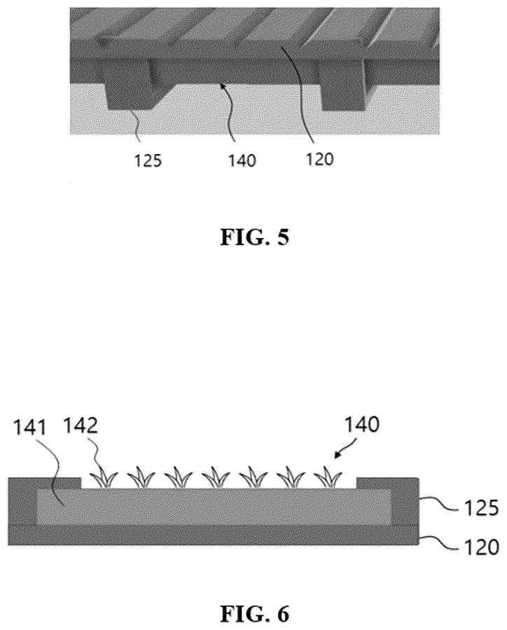

FIG. 5 and FIG. 6 show how to use the mat fixing members 125 to couple the natural grass mat 140 and the conveyor belt 120 with each other. Referring to FIG. 5, each of the mat fixing members 125 is in an L-shape or in a U-shape. Each of the first and the second mat fixing members (125) is formed in a L-shape. Each of the first and the second mat fixing members (125) is extending in the second direction from the conveyor belt (120) and bending in the L-shape in a third direction to accommodate the natural grass mat (140).

The third direction is perpendicular to the first direction and the second direction. FIG. 5 is an enlarged view of the area indicated “A” in FIG. 1. FIG. 6 is a cross-sectional view to illustrate how to couple the natural grass mat 140 and the conveyor belt 120 with each other using the mat fixing members 125.

FIG. 5 is the enlarged view of area “A” of FIG. 1, and FIG. 6 is a combined structure of a natural grass mat 140 and mat fixing members 125, showing the natural grass mat apparatus of FIG. 2 in cross-section A-A′. The natural grass mat 140 is provided over an outer surface the conveyor belt 120, and is fixed to the conveyor belt 120 by the mat fixing members 125.

Turning to FIG. 6, the mat fixing members 125 are installed on both edges of the conveyor belt 120 along the first direction. Both edges of the natural grass mat 140 may be accommodated into the mat fixing members 125 and fixedly secured to the both edges of the conveyor belt 120, respectively. At least a portion of the natural grass mat 140 may be exposed through the opening formed through the housing top surface 110a. The exposed natural grass mat 140 may be utilized as a golf practice mat.

In this case, the natural grass mat 140 may include a vegetation mattress 141, a layer of grass 142 grown from the vegetation mattress 141.

The vegetation mattress 141 may form a mattress net with natural fibers such as coconut fiber (COCO Coir), jute fiber (Jute Felt), or Rock Wool, and may include a mixture of natural materials such as natural rubber tree sap (LATEX) and nutrients for grass vegetation inside the mattress net, and a grass layer 142 modeled on the vegetation mattress 141 may be formed on the upper part of the vegetation mattress 141. Accordingly, the vegetation mattress 141 can help the layer of grass 142 continuously grow, and the elasticity of the mat can absorb swing impact of golf clubs or the like to protect the body of the user 2, and can secure elasticity according to the belt-type drive. Therefore, it is possible to practice under the same conditions as the real grass field as much as possible.

On the natural grass mat 140 of the present invention, the resistance, which is applied by the natural grass to a ball, a user can feel at the time of swing is almost the same as he or she can feel on a real outdoor grass field.

In addition, in general, when using a driving range mat, the swing impact may be transmitted to the wrist, arm, and shoulder. The natural grass mat 140 of the present invention uses natural grass and a mat material with low hardness (COCO Coir, Jute Felt, Rock Wool) which are excellent in shock absorption and in prevention of injury. Conditions of the natural grass mat 140 can be managed as needed, e.g., by adjusting length of the grass, immediately before use. In an embodiment, the natural grass mat 140 is managed to keep a fairway condition. In another embodiment, the natural grass mat 140 can be modified to keep a rough condition, etc. Thus, according to the present invention, it is possible to practice in various environments such as fairways and roughs.

Furthermore, the connecting portions 160a, 160b may connect between a pair of fixed support members that face each other and support different drive parts of the plurality of fixed support members. More specifically, referring to FIG. 2, the fixed support members may include a first fixed support member 150a and a third support member 150c for fixedly supporting both sides of the first drive part 130a. Likewise, a second fixed support member 150b and a fourth support member 150d for fixedly supporting both sides of the second drive part 130b.

The first fixed support member 150a and the second fixed support member 150b are connected to the first connecting portion 160a. Likewise, the third fixed support member 150c and the fourth fixed support member 150d are connected to the second connecting portion 160b, so that the drive parts 130a, 130b can be stably and rigidly fixedly supported. Furthermore, each of the first connecting portion 160a and the second connecting portion 160b is spaced apart from the conveyor belt 125 at a certain distance so as not to affect the conveyor drive.

In addition, rollers 170 are arranged side by side in the first direction. The rollers 170 are provided under an inner surface of the conveyor belt 120 and rotatably coupled between the first connecting portion 160a and the second connecting portion 160b to guide movement of the conveyor belt in the first direction, The inner surface of the conveyor belt 120 is the opposite side of the outer surface of the conveyor belt 120.

The rollers 170 are spaced apart from each other at a predetermined interval. In an embodiment, the rollers 170 may be formed on the top of the first connecting portion 160a and the second connecting portion 160b. The rollers 170 may be coupled between the first connecting portion 160a and the second connecting portion 160b in a rotatably movable manner, such as by bearings.

The rollers 170 may support a portion of the conveyor belt 120 (the conveyor belt 120 located on the housing top surface 110a), and may guide and direct movement of the conveyor belt 120 upon actuation of the drive parts 130a, 130b.

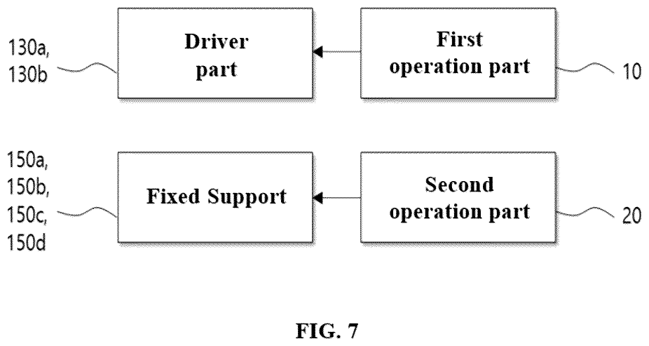

FIG. 7 is a drawing to illustrate operation parts 10, 20 according to an embodiment of the present invention. The natural grass matting apparatus according to an embodiment of the present invention further comprises a first operation part 10 and a second operation part 20. The first and the second drive parts 130a, 130b may be driven and controlled in response to a user control command via the first operation part 10. The natural grass mat apparatus may further include a first operation part 10 for controlling the drive parts 130a, 130b, to move the drive parts 130a, 130b. For example, in response to the first control command, the first and the second drive parts 130a, 130b rotationally drive the conveyor belt (120) to adjust locations, directions, or slopes of the drive parts 130a, 130b. In response to the second control command, the first and the second fixed support members 150a, 150) (i) extends in the second direction to lift up a height level of the natural grass mat 140, or (ii) retracts in the second direction to lower down the height level of the natural grass mat 140.

More specifically, the first operation part 10 may be a remote controller, either wired or wireless, and may input control commands to rotationally drive the drive parts 130a, 130b in one direction, e.g., in the first direction such that a portion of the natural grass mat exposed by the opening 110h is adjusted.

This allows the user to move the natural grass mat 140 to a desired location based on the condition of the grass. In addition, grass elasticity can be secured by the belt-type drive. Furthermore, the natural grass matting apparatus of the present invention can provide a large number of uses by conveying the natural grass mat 140 by the conveyor belt 120.

Furthermore, the second operation part 20 may be a remote controller in the form of a wired or wireless controller, and may receive a second control command to extend or retract the first, the second, the third, and the fourth fixed support members 150a, 150b, 150c, 150d (collectively, fixed support members 150a to 150d). The fixed support members 150a to 150d may be extended or retracted in response to the second control command.

The fixed support members 150a to 150d may be formed as a multi-stage structure, and the multi-stages may be extended or retracted in response to the second control command, such as by a hydraulic cylinder or gear drive. When a user needs to replace the natural grass mat 140 after multiple uses, the user can first remove the housing top surface 110a, and then extend the fixed support members 150a to 150d to lift up the housing 100 which is installed in the housing receptacle 110b, i.e., the conveyor belt 120, the drive parts 130a, 130b, the natural grass mat 140, the connecting portions 160a, 160b, and the roller 170. After lifting the housing 100, the natural grass mat 140 can be removed and replaced with a new natural grass mat 140.

Next, the fixed support members 150a to 150d may be retracted to reinstall the housing 100 in the housing receptacle 110b. Then, the housing top surface 110a may be rejoined. In one example, the housing top surface 110a may be coupled to the housing receptacle 110b by a snap fit, for example.

Embodiments of the present invention have been described in more detail with reference to the accompanying drawings, but the invention is not necessarily limited to these embodiments and may be practiced in various modifications without departing from the technical ideas of the invention. Accordingly, the embodiments disclosed herein are intended to illustrate and not to limit the technical ideas of the present invention, and the scope of the technical ideas of the present invention is not limited by these embodiments. Therefore, the embodiments described above are exemplary in all respects and should be understood as non-limiting. The scope of protection of the present invention shall be construed in accordance with the following claims, and all technical ideas within the scope of the same shall be construed as being included within the scope of the present invention.

EXPLANATION OF SYMBOLS

| | |
|---|---|
| 110: Housing | |
| 110a: Housing top surface, | 110b: Housing receptacle |
| 120: Conveyor belt | 125: Mat fixing member |
| 130a, 130b: Drive part | |
| 140: Natural grass mat | |
| 141: Vegetation mattress | 142: A layer of Grass |
| 150a to 150b: Fixed Support member | |
| 160a: first connecting portion | 160b: second connecting portion |
| 170: Roller | |
| 10: first operation part | 20: second operation part |
| 1: floor surface | 2: User |

What is claimed is:

1. A natural grass mat apparatus for golf practice, comprising:
a housing (100);
first and second drive parts (130a, 130b) provided in the housing (100) and arranged side by side along a first direction;
a conveyor belt (120) provided in the housing (100) and moving around the first and the second drive parts (130a, 130b);
a natural grass mat (140) provided over an outer surface of the conveyor belt (120);
a first fixed support member (150a) extending substantially in a second direction from the first drive part (130a) toward a bottom of the housing (100) and supporting the first drive parts (130a), wherein the second direction is perpendicular to the first direction; and
a second fixed support member (150b) extending substantially in the second direction from the second drive part (130b) toward the bottom of the housing (100) and supporting the second drive part (130a),
wherein an opening (110h) is formed through a housing top surface (110a) of the housing (100) to expose partially or entirely the natural grass mat (140).

2. The natural grass mat apparatus for golf practice according to claim 1, further comprising:
mat fixing members (125) coupling the natural grass mat (140) and the conveyor belt (120) with each other.

3. The natural grass mat apparatus for golf practice according to claim 1, wherein the natural grass mat (140) comprises:
a vegetation mattress (141) made using coconut fiber (COCO Coir), jute fiber (Jute Felt), Rock Wool, or a combination thereof; and
a vegetated grass layer (142) grown from the vegetation mattress (141),
wherein the vegetation mattress (141) includes grass nutrients and latex.

4. The natural grass mat apparatus for golf practice according to claim 1, further comprising:
a first operation part (10) transmitting a first control command to the first and the second drive parts (130a, 130b),
wherein, in response to the first control command, the first and the second drive parts (130a, 130b) rotationally drive the conveyor belt (120) to move the natural grass mat (140).

5. The natural grass mat apparatus for golf practice according to claim 4,
wherein each of the first and the second fixed support members (150a, 150b) is extendable and retractable in the second direction.

6. The natural grass mat apparatus for golf practice according to claim 5, further comprising:
a second operation part (20) transmitting a second control command to the first and the second drive parts (130a, 130b),
wherein, in response to the second control command, the first and the second fixed support members (150a, 150b) (i) extends in the second direction to lift up the natural grass mat (140) in the second direction, or (ii) retracts in the second direction to lower down the natural grass mat (140) in the second direction.

7. The natural grass mat apparatus for golf practice according to claim 5, further comprising:
a first connecting portion (160a) connecting the first fixed support member (150a) and the second fixed support member (150b) to each other.

8. The natural grass mat apparatus for golf practice according to claim 7, further comprising:
rollers (170) arranged side by side in the first direction,
wherein each of said rollers (170) provided under an inner surface of the conveyor belt (120) and rotatably coupled with the first connecting portion (160a) to guide movement of the conveyor belt in the first direction,
wherein the inner surface of the conveyor belt (120) is the opposite side of the outer surface of the conveyor belt (120).

9. The natural grass mat apparatus for golf practice according to claim 2,
wherein each of the first and the second mat fixing members (125) is formed in a L-shape,
wherein each of the first and the second mat fixing members (125) is extending in the second direction from the conveyor belt (120) and bending in the L-shape in a third direction to accommodate the natural grass mat (140),
wherein the third direction is perpendicular to the first direction and the second direction.
